(19) United States
(12) Patent Application Publication
(10) Pub. No.: US 2020/0337344 A1
(43) Pub. Date: Oct. 29, 2020

(54) CONTROLLING THE WATER CONTENT TO REFINERS FOR PROCESSING SURIMI AND OTHER MINCES

(71) Applicants: Christopher Campbell Riley, Federal Way, WA (US); Mette Kristina Joensen, Vedbaek (DK)

(72) Inventors: Christopher Campbell Riley, Federal Way, WA (US); Mette Kristina Joensen, Vedbaek (DK)

(21) Appl. No.: 16/845,952

(22) Filed: Apr. 10, 2020

Related U.S. Application Data
(60) Provisional application No. 62/837,249, filed on Apr. 23, 2019.

(51) Int. Cl. A23L 17/00; A22C 25/02; B30B 9/12

(52) U.S. Cl. CPC A23L 17/70; B30B 9/12; A22C 25/02

(57) ABSTRACT

A method of processing mince for making surimi comprises washing the mince with water; refining the mince in a perforated refiner drum that produces a layer of mince on the inside surface of the perforated refiner drum; and after washing and before refining, dewatering the mince with a screw press that removes water from the mince before feeding to the refiner drum.

### CROSS-REFERENCE(S) TO RELATED APPLICATION(S)

This application claims the benefit of U.S. Provisional Application No. 62/837,249, filed Apr. 23, 2019. This application is expressly incorporated herein by reference.

### BACKGROUND

A problem arises in processing surimi via the use of refiners due to the water included in the mince sent to the refiner. Either excess water or insufficient water to the refiner will lead to poor separation of impurities and result in low quality surimi or low yields or both. The present application discloses a process of producing high quality surimi via a refiner while also maintaining high yield.

### SUMMARY

In one embodiment, a method of processing mince comprises washing the mince with water; refining the mince in a perforated refiner drum that produces a layer of mince on the inside surface of the perforated refiner drum; and after washing and before refining, dewatering the mince with a screw press that removes water from the mince before feeding to the refiner drum.

In one embodiment of the method of processing mince, the dry solids content of the mince after washing the mince with water and before dewatering the mince is from 3% by weight to 10% by weight.

In one embodiment of the method of processing mince, the dry solids content of the mince after dewatering the mince and before refining the mince is from 9% by weight plus/minus 1.5% by weight.

In one embodiment, the method of processing mince further comprises, after washing the mince with water, and before dewatering with the screw press, screening the washed mince.

In one embodiment of the method of processing mince, screening the washed mince is performed with a rotary screen or a vibratory screen.

In one embodiment of the method of processing mince, the screw press includes a rotating shaft that increases in outer diameter as mince is transferred along the screw press.

In one embodiment of the method of processing mince, the screw press includes a screw blade having decreasing distances between adjacent flights of the screw blade.

In one embodiment of the method of processing mince, the mince is from a fish, mammal, or poultry

In one embodiment of the method of processing mince, the fish is selected from the group consisting of Alaska Pollock (Theragra chalcogramma), Pacific whiting (Merluccius productus), Atlantic cod (Gadus morhua), Pacific cod (Gadus macrocephalus), Croaker (Pennahia macrocephalus), Bigeye (Priacanthus arenatus), Tilapia (Oreochromis mossambicus), Southern Blue whiting (Micromesistius australis), Blue whiting (Micromesistius poutassou), Basa (Pangasius bocourti), Carp (Cyprinidae spp.), Hake or Cod (Gadidae spp.), Catfishes (order Siluriformes), Atlantic salmon (Salmo solar), Chinook salmon (Oncorhynchus tshawytscha), Chum salmon (Oncorhynchus keta), Coho salmon (Oncorhynchus kisutch), Pink salmon (Oncorhynchus gorbuscha), Sockeye salmon (Oncorhynchus nerka), a Cyprinidae, and a carp, or any combination thereof.

In one embodiment of the method of processing mince, the perforated refiner drum has perforations of from 1 mm to 1.5 mm in diameter.

In one embodiment of the method of processing mince, the method further comprises after dewatering the mince with the screw press and before refining the mince, adding water to the mince to reach a dry solids content of about 9% plus/minus 1.5% by weight before refining the mince.

In one embodiment of the method of processing mince, the method further comprises forming a layer of mince in a gap between a distal edge of a rotating paddle inside the drum and an inner surface of the drum.

In one embodiment, a method of making cryoprotected surimi comprises washing fish flesh mince with water; refining the mince in a perforated refiner drum that produces a layer of mince on the inside surface of the perforated refiner drum; after washing and before refining, dewatering the mince with a screw press that removes water from the mince before feeding to the refiner drum; after refining, performing a second dewatering step on the refined mince; and after the second dewatering step, adding cryoprotectants to the mince.

In one embodiment, a system for the processing of mince comprises a wash section having one or more screens; a refiner downstream from the wash section, the refiner has a perforated drum; and a screw press downstream from the wash section and upstream from the refiner.

In one embodiment of the system for processing of mince, the refiner has perforations from 1 mm to 1.5 mm in diameter.

In one embodiment of the system for processing of mince, the screens are vibrating screens or rotating screens.

In one embodiment of the system for processing of mince, the screw press includes a rotating shaft that increases in outer diameter as mince is transferred along the screw press.

In one embodiment of the system for processing of mince, the screw press includes a screw blade having decreasing distances between adjacent flights of the screw blade.

In one embodiment of the system for processing of mince, the screw press has a perforated outer casing along the length and circumference of the outer casing.

In one embodiment of the system for processing of mince, the drum of the refiner has perforations around the circumference and length of the drum.

In one embodiment of the system for processing of mince, the drum of the refiner has a gap of about 0.5 to 2.5 mm between an end of a distal edge of a paddle inside the drum and an inner surface of the drum.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a prior art method for processing surimi;

FIG. 2 is a flow diagram of a method for processing surimi in accordance with embodiments of the disclosure;

FIG. 3 is a cross sectional diagrammatical illustration of a refiner;

FIG. 4 is a cross sectional diagrammatical illustration of a screw press; and

FIG. 5 is a cross sectional diagrammatical illustration of a screw press.

### DETAILED DESCRIPTION

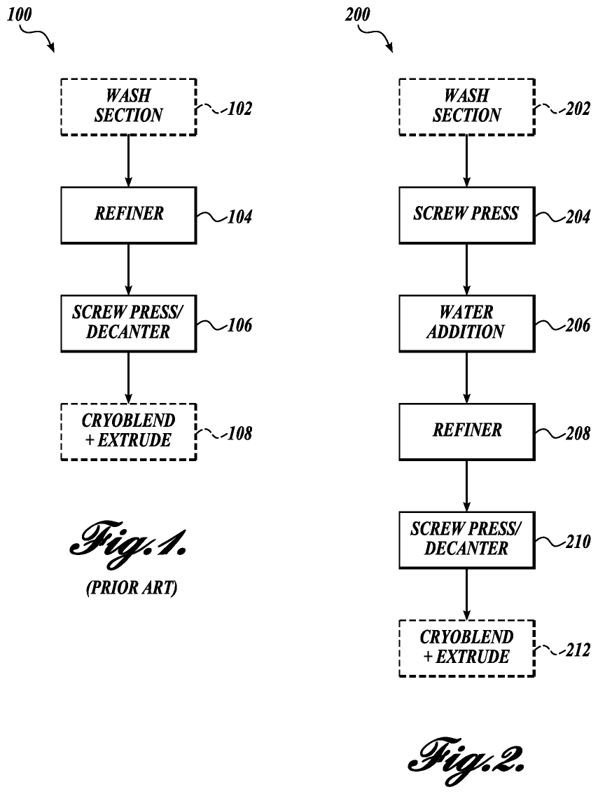

Referring to FIG. 1, a generalized conventional process for processing mince includes a wash section 102, followed immediately by the refiner 104. The refiner 104 is followed immediately by the screw press or decanter centrifuge 106, and the decanter or centrifuge 106 is followed by optional blending with cryoprotectants, extrusion, finishing or other steps. Surimi will be used as an exemplary mince, however, mince for use in the embodiments of this disclosure can come from sources including, but not limited to fish, poultry, and beef, such as cow, pig, lamb, and goat.

In making surimi from fish, the fish is de-headed, gutted, sometimes filleted, and deboned by using well-known machinery. After deboning and gutting, the fish flesh is made into mince by well-known machinery, such as by forcing the fish flesh to pass through a perforated steel drum having holes in the range of from 2-7 mm in diameter, and usually from 3-5 mm, in diameter. Many variations of deboning and mincing fish flesh exist. The extent to which the fish is minced is oftentimes dictated by the quality of the surimi desired to be produced or by balancing the amount of fish flesh desired to be recovered versus the cost to recover it.

Generally, mince intended for surimi is washed with water, and thereafter, the water is separated via screens. Screens such as vibratory screens and rotating screens remove some of the water following washing. Step 102 is termed “wash section” to not limit the wash to any particular set of steps and to denote that in the wash section, many variations of washing and screening are possible. In the wash section, the amount of water, the time of washing, the screen mesh size, the time of screening, and the number of washing/separating cycles can vary depending on the mince being produced and the specifications. Washing the mince with water removes undesirable water-soluble sarcoplasmic protein, enzymes, and blood, and concentrates the myofibrillar protein. Myofibrillar protein is more desirable for surimi because the myofibrillar protein produces the gel-forming ability characteristic of surimi, while the sarcoplasmic protein only detracts from this ability.

In conventional washing processes, the wash water is combined with mince in a batch, continuous batch, continuous tank, or “pipe” wash. Many times, the washing and separating steps are performed in the same machinery. For example, a perforated rotating drum spins around its central axis while the wash water is sprayed onto the outside of the drum and mixes with the tumbling fish flesh inside the tank. The spraying is stopped, and then the water is induced to separate from the fish flesh through perforations in the drum as the drum rotates. The amount of water, the temperature, and the time of the wash and separate steps can all be adjusted to produce surimi having selected characteristics, such as color and gel-forming ability.

Many conventional surimi plants that have been built in recent years utilize a refiner to separate the more functional fraction of the washed mince from the less functional fraction. In conventional processes, the refining step takes place immediately after the last screen of the wash section 102 and immediately before the dewater step via a screw press or decanter 106. A problem with the conventional process is the inability to positively control the moisture content of the washed mince being fed to the refiner after the screens, which results in an excess of moisture. Conventional refiners rely on the buildup of a filter mat of protein tissue inside the refiner drum. The layer is a result of the mince being flung by centrifugal force against the inside surface of the refiner drum. In some embodiments, the refiner paddle within the drum spins from about 100 rpm to about 400 rpm. Excessively wet mince prevents the formation of this mat, or washes away an existing mat in refiners that have a drum screen hole diameter even on the order of 1 mm to 1.5 mm in diameter.

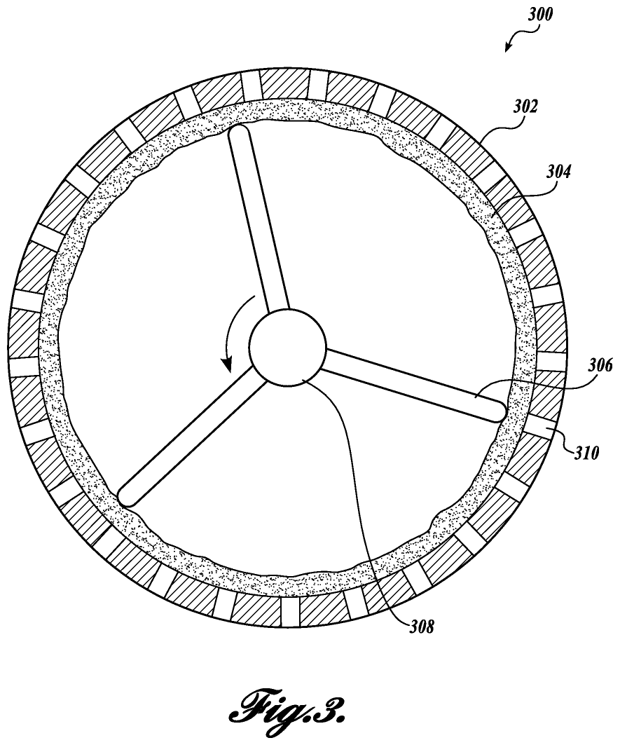

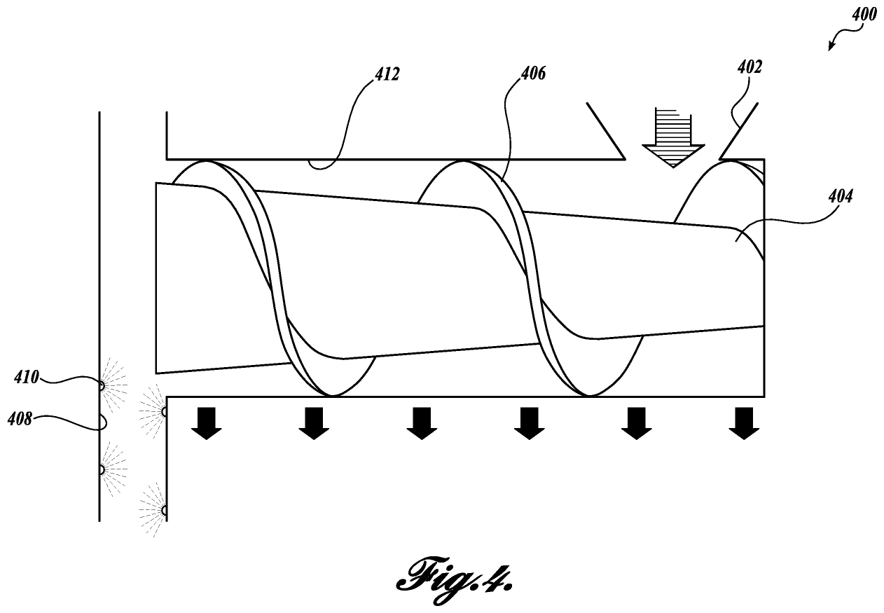

FIG. 3 shows a cross section of a conventional refiner 300 used in steps 104 and 208 of FIGS. 1 and 2, respectively. In an embodiment, the refiner 300 includes a drum 302. In an embodiment, the drum 302 includes perforations 310 around the circumference and length of the drum 302. In some embodiments, the perforations 310 are approximately 1 mm to 1.5 mm in diameter. However, other embodiments of the refiner 300 can have perforations smaller than 1 mm and greater than 1.5 mm in diameter. A shaft 308 connected to a motor (not shown) is supported in the center of the refiner drum 302. One or more paddles 306 are mounted to the shaft 308. Each paddle 306 extends both radially and longitudinally in the drum 302. In an embodiment, each paddle 306 has a helical shape as it is wound around the shaft. As seen in FIG. 3, the paddles 306 extend radially but do not touch the inner surface of the drum 302. A gap of about 0.5 to 2.5 mm exists between the end of the distal edge of a paddle 306 and the inner surface of the drum 302. A layer 304 of mince accumulates in the gap between the distal edge of the paddle 306 and the inner surface of the drum 302. The layer 304 or mat of tissue acts as a filter in the refiner. The layer 304 is a result of the mince being flung by centrifugal force against the inside surface of the refiner drum 302. In some embodiments, the refiner paddle in the refiner drum 302 spins from about 100 rpm to about 400 rpm. Other refiner designs that could be used in the present disclosure include a conical screw refiner, such as from Paoli and Beehive.

However, in processes represented generally by FIG. 1, the moisture content of the mince from the wash section 102 is not wholly controllable, and excess moisture to the refiner 300 results in poor performance. Traditionally, there are two ways of handling excessively wet mince to the refiner. The first includes reducing the wash time or amount of water. The second includes increasing the screening time or screen mesh size. However, reducing the wash water or time results in a loss of quality such as, an increased number of impurities, reduction of gel strength, and an increase in color. Increasing the screening results in increased loss of protein or a reduction in line capacity.

This disclosure addresses the problem of excess moisture to the refiner. This disclosure includes the step of further dewatering the washed mince with a screw press after the wash section step and prior to the refining step. Ideally the screw press reduces the moisture content in the washed mince to a level lower than that desirable for the refiner feed. This allows positive control of the moisture in the refiner feed by introducing water to reach the desired moisture level. The method avoids having to decrease the wash water or time, and avoids having to increase the screen time or mesh size in order to reduce excess moisture.

Referring to FIG. 2, the processing of mince in accordance with embodiments of this disclosure include washing and screening the mince with water in the wash section, step 202, refining the mince in a perforated refiner drum that produces a layer of mince on the inside surface of the perforated refiner drum, step 208, and after the washing/screening and before refining, dewatering the mince with a screw press that removes water from the mince fed to the refiner drum, step 204. In FIG. 2, the steps for initially producing the mince are not shown for brevity. However, how the mince is acquired is not particularly limiting. The wash section, step 202, is also not particularly limited to any process or machinery. In an embodiment, the mince wash section can be a conventional wash and screening section using conventional machinery. In an embodiment, the number of wash cycles can be one, two, or more than two. In one embodiment, the dry solids content of mince leaving the wash section is in the range from 3% by weight to 10% by weight. The solids content in this disclosure relates to the dry solids (DS) content.

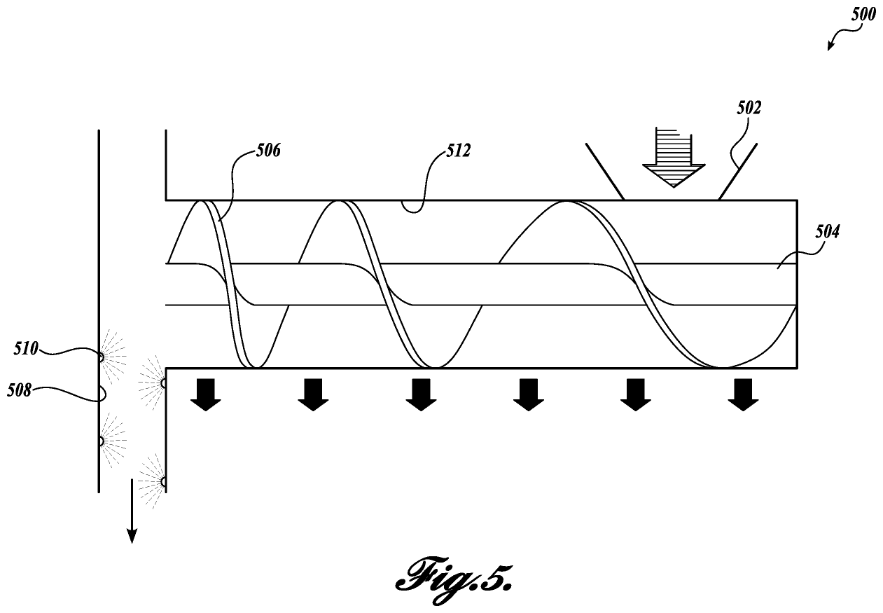

In FIG. 2, in one embodiment, the refiner, step 208, includes a refiner that operates by the formation of a thin layer of mince on the inside surface of a perforated refiner drum, as shown in FIG. 3, such as those already described. In FIG. 2, in one embodiment, the screw press, step 204, uses a screw press generally as shown in FIG. 4.

In FIG. 4, a suitable screw press 400 for step 204 includes an outer casing 412. The outer casing 412 is perforated along the length and circumference of the outer casing 412. A shaft 404 is supported in the center of the outer casing 412. The shaft 404 is connected to a motor (not shown) to turn the shaft 404. In one embodiment, the shaft 404 is conical shaped having a gradually increasing outer diameter that starts from a relative small diameter at the entrance feed hopper 402 to a relative larger diameter at the press cake exit 408, while the inner diameter of the casing 412 remains constant or nearly constant. This design applies a compressive force as the contents are transferred from the entrance to the exit of the screw press 400.

In one embodiment, a helical screw blade 406 is wound around and attached to the shaft 404. The screw blade 406 may be of various designs. In one embodiment, the number of flights per distance remain constant. That is the, flights of the screw 406 are spaced equally apart. The radial distance, that is, the distance from the shaft 404 to the casing 412 of the flights is greatest at the entrance and the radial distance diminishes along the length of the screw press 400. As can be appreciated as the shaft 404 is turned, the helical screw blade 406 will move mince from the feed hopper 402 to the exit 408 gradually compressing the mince as it travels the length of the screw press, thus squeezing water from the mince that leaves through the porous casing. In an embodiment, the moisture levels from the screw press 204 of FIG. 2 are lower than what is achievable by conventional screens in the wash section 202.

In an embodiment, water spray nozzles 410 are positioned to spray the mince exiting the screw press 400. In spraying, the water breaks up the mince to incorporate the added water. In an embodiment, the amount of water sprayed onto the mince from the screw press is controlled via a control valve to produce a mince having the correct amount of water for the refiner, step 208.

In FIG. 5, another suitable screw press 500 for step 204 includes an outer casing 512. The outer casing 512 is perforated along the length and circumference of the outer casing 512. A shaft 504 is supported in the center of the outer casing 512. The shaft 504 is connected to a motor (not shown) to turn the shaft 504. In one embodiment, the shaft 504 has a constant outer diameter. In one embodiment, a helical screw blade 506 is wound around and attached to the shaft 504. However, the distance from one adjacent flight to the next is not constant. In one embodiment, the distance from one adjacent flight to the next decreases along the length of the screw blade 506. Thus, flights are spaced relatively far apart at the entrance 502 compared to the exit 508. This design applies a compressive force as the contents are transferred from the entrance to the exit of the screw press 500. As can be appreciated as the shaft 504 is turned, the helical screw blade 506 will move mince from the feed hopper 502 to the exit 508 gradually compressing the mince as it travels the length of the screw press, thus squeezing water from the mince that leaves through the porous casing.

In an embodiment, water spray nozzles 510 are positioned to spray the mince exiting the screw press 500. In spraying, the water breaks up the mince to incorporate the added water. In an embodiment, the amount of water sprayed onto the mince from the screw press is controlled via a control valve to produce a mince having the correct amount of water for the refiner, step 208.

The correct amount of water will vary depending on the source of the mince, the product specifications, and other factors. In an embodiment, for surimi, the dry solids content of the mince fed to the refiner, step 208, can be in the range of 9% by weight plus/minus 1.5% by weight, for example. The problem of excessive moisture to the refiner is eliminated via the use of a screw press 204 alone or a screw press 204 combined with a water addition step 206. For example, in one embodiment, the dry solids content of mince out of the screw press 204 is about 14% by weight plus/minus 1% by weight. Then, water addition provides the dry solids content of mince in the range of the 9% by weight plus/minus 1.5%. Further, the disclosed process has the advantage that the parameters of the washing section 206 will not need to be adjusted in order to feed the refiner the mince with the proper amount of moisture.

In one embodiment, the water addition step 206 functions as an additional “wash” step (like a dilution step), with the refining step 208 being in the middle of the wash cycle starting with the water addition step 206, the refining step 208 is performed during the middle of the wash cycle, and the wash is completed with the screw press/decanter step 210.

From the screw press, step 204, the mince passes to the refiner 208, or if the process includes water addition, step 206, the mince passes from water addition, step 206, to the refiner 208. In an embodiment, the refiner 208 is a refiner as has been described in association with FIG. 3. However, the moisture content of the mince has been controlled accurately through the addition of steps 204, and optionally, step 206. In an embodiment, for surimi, the dry solids content of the mince exiting the refiner, step 208, can be in the range of 9% by weight plus/minus 1% or only slightly less than at the inlet to the refiner 208. Dry solids content is easily measured using any one of a number of techniques, such as Coriolis meter, IR, etc.

From the refiner, step 208, the mince is dewatered in a second screw press or decanter centrifuge, step 210. In one embodiment, after step 208 the dry solids content of mince is about 18% plus/minus 1.5% by weight. After the second screw press/decanter, step 210, the mince can be combined with cryoprotectants, such as sucrose, sorbitol, and sodium tripolyphosphate, and then frozen using conventional equipment.

Referring to FIGS. 1 to 5, this disclosure also relates to a system that in one embodiment can be used for processing mince. The system can be one that operates continuously or in batches. The system is comprised, or equipment arranged in sequence, wherein certain equipment is placed either upstream of downstream of other equipment. In one embodiment, product can be moved either continuously through the equipment or in batches.

In one embodiment, a system for the processing of mince comprises a wash section having one or more screens; a refiner downstream from the wash section, the refiner has a perforated drum; and a screw press downstream from the wash section and upstream from the refiner.

In one embodiment of the system for processing of mince, the refiner has perforations from 1 mm to 1.5 mm in diameter.

In one embodiment of the system for processing of mince, the screens are vibrating screens or rotating screens.

In one embodiment of the system for processing of mince, the screw press includes a rotating shaft that increases in outer diameter as mince is transferred along the screw press.

In one embodiment of the system for processing of mince, the screw press includes a screw blade having decreasing distances between adjacent flights of the screw blade.

In one embodiment of the system for processing of mince, the screw press has a perforated outer casing along the length and circumference of the outer casing.

In one embodiment of the system for processing of mince, the drum of the refiner has perforations around the circumference and length of the drum.

In one embodiment of the system for processing of mince, the drum of the refiner has a gap of about 0.5 to 2.5 mm between an end of a distal edge of a paddle inside the drum and an inner surface of the drum.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of processing mince, comprising:
washing the mince with water;
refining the mince in a perforated refiner drum that produces a layer of mince on the inside surface of the perforated refiner drum; and
after washing and before refining, dewatering the mince with a screw press that removes water from the mince before feeding to the refiner drum.

2. The method of claim 1, wherein the dry solids content after washing the mince with water and before dewatering the mince is from 3% by weight to 10% by weight.

3. The method of claim 1, wherein the dry solids content after dewatering the mince and before refining the mince is from 9% by weight plus/minus 1.5% by weight.

4. The method of claim 1, further comprising, after washing the mince with water, and before dewatering with the screw press, screening the washed mince.

5. The method of claim 4, wherein screening the washed mince is performed with a rotary screen or a vibratory screen.

6. The method of claim 1, wherein the screw press includes a rotating shaft that increases in outer diameter as mince is transferred along the screw press.

7. The method of claim 1, wherein the screw press includes a screw blade having decreasing distances between adjacent flights of the screw blade.

8. The method of claim 1, wherein the mince is from a fish, mammal, or poultry.

9. The method of claim 8, wherein the fish is selected from the group consisting of Alaska Pollock (Theragra chalcogramma), Pacific whiting (Merluccius productus), Atlantic cod (Gadus morhua), Pacific cod (Gadus macrocephalus), Croaker (Pennahia macrocephalus), Bigeye (Priacanthus arenatus), Tilapia (Oreochromis mossambicus), Southern Blue whiting (Micromesistius australis), Blue whiting (Micromesistius poutassou), Basa (Pangasius bocourti), Carp (Cyprinidae spp.), Hake or Cod (Gadidae spp.), Catfishes (order Siluriformes), Atlantic salmon (Salmo salar), Chinook salmon (Oncorhynchus tshawytscha), Chum salmon (Oncorhynchus keta), Coho salmon (Oncorhynchus kisutch), Pink salmon (Oncorhynchus gorbuscha), Sockeye salmon (Oncorhynchus nerka), a Cyprinidae, and a carp, or any combination thereof.

10. The method of claim 1, wherein the perforated refiner drum has perforations of from 1 mm to 1.5 mm.

11. The method of claim 1, further comprising after dewatering the mince with the screw press and before refining the mince, adding water to the mince to reach a dry solids content of about 9% plus/minus 1.5% by weight before refining the mince.

12. The method of claim 1, further comprising forming a layer of mince in a gap between a distal edge of a rotating paddle inside the drum and an inner surface of the drum.

13. A method of making cryoprotected surimi, comprising:
washing fish flesh mince with water;
refining the mince in a perforated refiner drum that produces a layer of mince on the inside surface of the perforated refiner drum;
after washing and before refining, dewatering the mince with a screw press that removes water from the mince before feeding to the refiner drum;
after refining, performing a second dewatering step on the refined mince; and
after the second dewatering step, adding cryoprotectants to the mince.

14. A system for the processing of mince, comprising:
a wash section having one or more screens;
a refiner downstream from the wash section, the refiner has a perforated drum; and
a screw press downstream from the wash section and upstream from the refiner.

15. The system of claim 14, wherein the screens are vibrating screens or rotating screens.

16. The system of claim 14, wherein the screw press includes a rotating shaft that increases in outer diameter as mince is transferred along the screw press.

17. The system of claim 14, wherein the screw press includes a screw blade having decreasing distances between adjacent flights of the screw blade.

18. The system of claim 14, wherein the screw press has a perforated outer casing along the length and circumference of the outer casing.

19. The system of claim 14, wherein the drum of the refiner has perforations around the circumference and length of the drum.

20. The system of claim 14, wherein the drum of the refiner has a gap of about 0.5 to 2.5 mm between an end of a distal edge of a paddle inside the drum and an inner surface of the drum.
